(19) United States
(12) Patent Application Publication
(10) Pub. No.: US 2024/0313626 A1
(43) Pub. Date: Sep. 19, 2024

(54) POWER SUPPLY CIRCUIT AND CONTROL METHOD THEREOF

(71) Applicant: Realtek Semiconductor Corporation, Hsinchu (TW)

(72) Inventors: Li Cheng CHU, Hsinchu (TW); Leaf CHEN, Hsinchu (TW)

(21) Appl. No.: 18/593,964

(22) Filed: Mar. 3, 2024

(30) Foreign Application Priority Data
Mar. 13, 2023 (TW) 112109147

(51) Int. Cl. H02M 1/00; H02M 1/088; H02M 1/32; H02M 3/158

(52) U.S. Cl. CPC H02M 1/0029; H02M 1/088; H02M 1/32; H02M 3/158

(57) ABSTRACT

A power supply circuit includes a power switch circuit, a slew rate sensing circuit, a reference voltage generator circuit, and a first protection circuit. The power switch circuit is configured to generate an output current to an output terminal of power switch circuit according to an input voltage at an input terminal. The slew rate sensing circuit is configured to generate a sensing voltage according to an output voltage at the output terminal of the power switch circuit. The reference voltage generator circuit is configured to generate a reference voltage according to the input voltage. The first protection circuit is configured to generate a control voltage according to the reference voltage and the sensing voltage to control a turned-on degree of the power switch circuit.

### RELATED APPLICATIONS

This application claims priority to Taiwanese Application Serial Number 112109147, filed Mar. 13, 2023, which is herein incorporated by reference.

### BACKGROUND

### Technical Field

The present disclosure relates to power supply technology. More particularly, the present disclosure relates to a power supply circuit with an optimized short-circuit protection mechanism and a control method thereof.

### Description of Related Art

With developments of technology, various circuits have been developed. In practical applications, there are one or more power switches in many circuits. By controlling the one or more power switches in a circuit, an output current can be provided to an output terminal of the circuit such that a load coupled to the circuit can operate normally. However, when a short-circuit event occurs at the output terminal, it will cause an excessive output current to flow through the one or more power switches, and even cause the circuit to burn out.

### SUMMARY

Some aspects of the present disclosure are to provide a power supply circuit. The power supply circuit includes a power switch circuit, a slew rate sensing circuit, a reference voltage generator circuit, and a first protection circuit. The power switch circuit is configured to generate an output current to an output terminal of the power switch circuit according to an input voltage at an input terminal. The slew rate sensing circuit is configured to generate a sensing voltage according to an output voltage at the output terminal of power switch circuit. The reference voltage generator circuit is configured to generate a reference voltage according to the input voltage. The first protection circuit is configured to generate a control voltage according to the reference voltage and the sensing voltage to control a turned-on degree of the power switch circuit.

Some aspects of the present disclosure are to provide a control method of a power supply circuit. The control method includes following operations; generating, by a power switch circuit, an output current to an output terminal of the power switch circuit according to an input voltage at an input terminal; generating, by a slew rate sensing circuit, a sensing voltage according to an output voltage at the output terminal of the power switch circuit; generating, by a reference voltage generator circuit, a reference voltage according to the input voltage; and generating, by a first protection circuit, a control voltage according to the reference voltage and the sensing voltage to control a turned-on degree of the power switch circuit.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a power supply circuit according to some embodiments of the present disclosure.

FIG. 2 is a waveform diagram of the power supply circuit in FIG. 1 according to some embodiments of the present disclosure.

FIG. 3 is a schematic diagram of a delay circuit in FIG. 1 according to some embodiments of the present disclosure.

FIG. 4 is a waveform diagram of the delay circuit in FIG. 3 according to some embodiments of the present disclosure.

FIG. 5 is a schematic diagram of operations of a transient state protection circuit in FIG. 1 according to some embodiments of the present disclosure.

FIG. 6 is a schematic diagram of operations of a transient state protection circuit in FIG. 1 according to some embodiments of the present disclosure.

FIG. 7 is a flowchart diagram of a control method of a power supply circuit according to some embodiments of the present disclosure.

### DETAILED DESCRIPTION

In the present disclosure, “connected” or “coupled” may refer to “electrically connected” or “electrically coupled.” “Connected” or “coupled” may also refer to operations or actions between two or more elements.

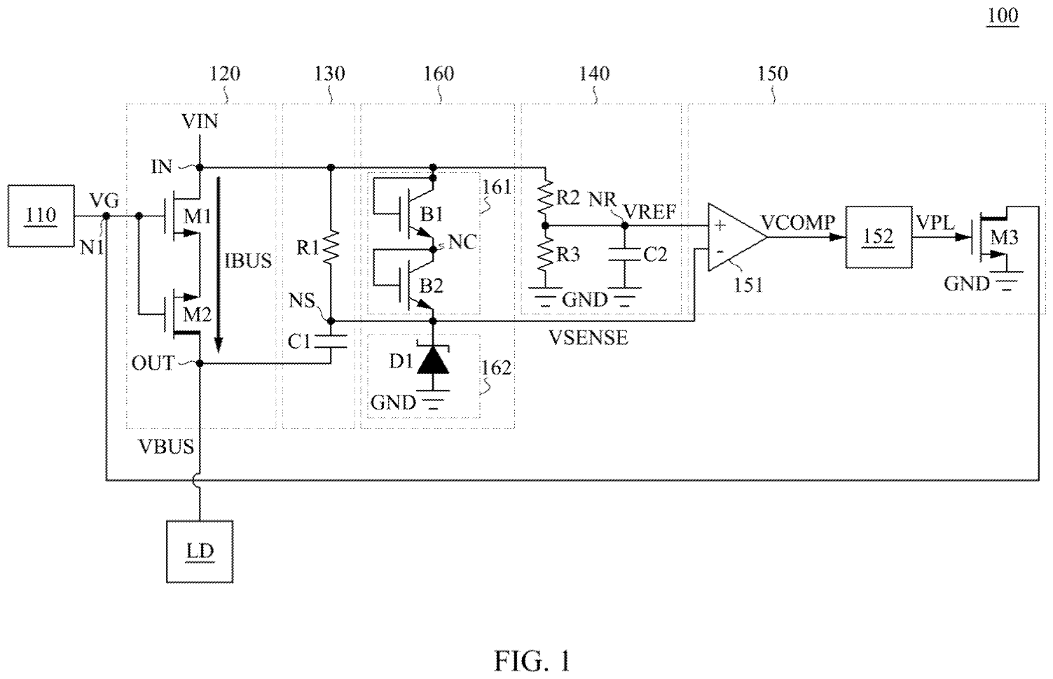

Reference is made to FIG. 1. FIG. 1 is a schematic diagram of a power supply circuit 100 according to some embodiments of the present disclosure.

As illustrated in FIG. 1, the power supply circuit 100 includes a voltage generator circuit 110, a power switch circuit 120, a slew rate sensing circuit 130, a reference voltage generator circuit 140, and a protection circuit 150.

Regarding the coupling relationship, the voltage generator circuit 110 is coupled to the power switch circuit 120. The power switch circuit 120 is coupled to the slew rate sensing circuit 130. The slew rate sensing circuit 130 is coupled to the reference voltage generator circuit 140. The reference voltage generator circuit 140 is coupled to the protection circuit 150. The protection circuit 150 is coupled to the power switch circuit 120.

In some embodiments, the power supply circuit 100 further includes a protection circuit 160. The protection circuit 160 is coupled between the slew rate sensing circuit 130 and the reference voltage generator circuit 140.

The voltage generator circuit 110 can generate a control voltage VG at a node N1 and provide the control voltage VG to the power switch circuit 120.

The power switch circuit 120 can generate an output current IBUS to an output terminal OUT according to an input voltage VIN (e.g., 5 volts) at an input terminal IN, and provide the output current IBUS to a load LD. Accordingly, an output voltage VBUS is generated at the output terminal OUT.

As illustrated in FIG. 1, the power switch circuit 120 includes a power switch M1 and a power switch M2. The power switch M1 and the power switch M2 are connected back to back between the input terminal IN and the output terminal OUT. In other words, a source terminal of the power switch M1 is directly coupled to a source terminal of the power switch M2 such that a body diode of the power switch M1 and a body diode of the power switch M2 are disposed in a reverse direction. Accordingly, it can prevent the output current IBUS from flowing back from the load LD. This architecture can be applied to some standards (e.g., USB Type-C). However, the present disclosure is not limited thereto.

In addition, in an example of FIG. 1, the power switch M1 and the power switch M2 are N-type transistors. Since a drift velocity of a N-type transistor is faster, this architecture has the advantage of a smaller area. Since the power switch M1 and the power switch M2 are N-type transistors, the voltage generator circuit 110 can include a charge pump circuit. The charge pump circuit provides the control voltage VG to a control terminal (a gate terminal) of the power switch M1 and a control terminal (a gate terminal) of the power switch M2 to control a turned-on degree (conduction status) of the power switch M1 and a turned-on degree of the power switch M2.

Further, in the example of FIG. 1, the power switch M2 is a high-voltage transistor. The “high-voltage transistor” here refers to a transistor with a higher withstand voltage (e.g., a withstand voltage of 20 volts). In other words, a withstand voltage of the power switch M2 is higher than a withstand voltage of the power switch M1. However, the present disclosure is not limited thereto.

It should be noted that the present disclosure is not limited to the power switch circuit 120 including two power switches. Power switch circuits in some other embodiments can include only one power switch or more than two power switches. In addition, the present disclosure is not limited to the power switch circuit implemented by N-type transistors. Power switch circuits in some other embodiments can be implemented by P-type transistors.

The slew rate sensing circuit 130 can generate a sensing voltage VSENSE at a sensing node NS according to the output voltage VBUS.

As illustrated in FIG. 1, the slew rate sensing circuit 130 includes a resistor R1 and a capacitor C1. The resistor R1 is coupled between the input terminal IN and the sensing node NS. The capacitor C1 is coupled between the sensing node NS and the output terminal OUT. The resistor R1 and the capacitor C1 form a high-pass filter (HPF). When the output voltage VBUS changes slightly, the sensing voltage VSENSE will change slightly. When the output voltage VBUS changes drastically, the sensing voltage VSENSE will change drastically. By adjusting a resistance value of the resistor R1 and a capacitance value of the capacitor C1, a bandwidth of the high-pass filter can be adjusted to detect a slew rate of the output voltage VBUS.

The reference voltage generator circuit 140 can generate a reference voltage VREF at a reference node NR according to the input voltage VIN.

As illustrated in FIG. 1, the reference voltage generator circuit 140 includes a resistor R2, a resistor R3, and a capacitor C2. The resistor R2 is coupled between the input terminal IN and the reference node NR. The resistor R3 and the capacitor C2 are coupled in parallel between the reference node NR and a ground terminal GND. The resistor R2 and the resistor R3 form a voltage divider circuit to divide the input voltage VIN. By adjusting a resistance value of the resistor R2 and a resistance value of the resistor R3, a voltage value of the reference voltage VREF can be adjusted. In some embodiments, the reference voltage VREF is designed to be about 90% of the input voltage VIN. In other words, when the input voltage VIN is 5 volts, the reference voltage VREF can be designed to be 4.5 volts by designing the resistance value of the resistor R2 and the resistance value of the resistor R3, but the present disclosure is not limited to these voltage values. In this architecture, when the resistance value of the resistor R2, the resistance value of the resistor R3, and a capacitor value of the capacitor C2 are fixed, the reference voltage VREF changes as the input voltage VIN changes. In addition, the resistor R2 and the capacitor C2 form a low-pass filter (LPF), which can avoid the problem of voltage instability during a short-circuit duration.

The protection circuit 150 can generate the control voltage VG according to the reference voltage VREF and the sensing voltage VSENSE to control a turned-on degree of the power switch circuit 120.

As illustrated in FIG. 1, the protection circuit 150 includes a comparator 151 and a transistor M3. A positive input terminal of the comparator 151 is coupled to the reference node NR to receive the reference voltage VREF. A negative input terminal of the comparator 151 is coupled to the sensing node NS to receive the sensing voltage VSENSE. The comparator 151 can compare the reference voltage VREF with the sensing voltage VSENSE to generate a comparison voltage VCOMP at an output terminal of the comparator 151. The transistor M3 is coupled between the output terminal of the comparator 151, the ground terminal GND, and the power switch circuit 120. The comparison voltage VCOMP can be configured to control a turned-on degree of the transistor M3.

In some embodiments, the protection circuit 150 further includes a delay circuit 152. The delay circuit 152 can delay a falling edge of the comparison voltage VCOMP to generate a delayed voltage VPL and transmit the delayed voltage VPL to a control terminal (a gate terminal) of the transistor M3 to control the turned-on degree of the transistor M3. In the example of FIG. 1, the transistor M3 is a high-voltage transistor, but the present disclosure is not limited thereto.

The protection circuit 160 can limit the sensing voltage VSENSE to a more appropriate range to protect the comparator 151.

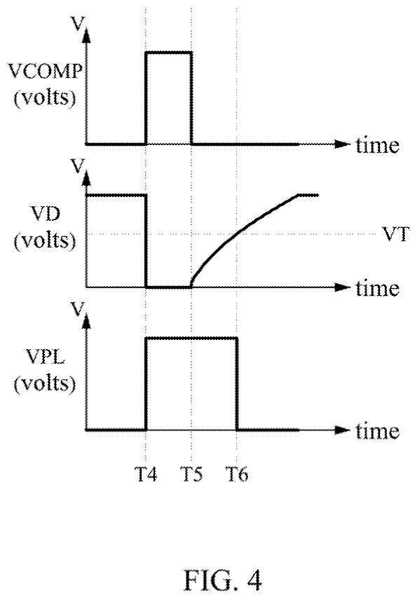

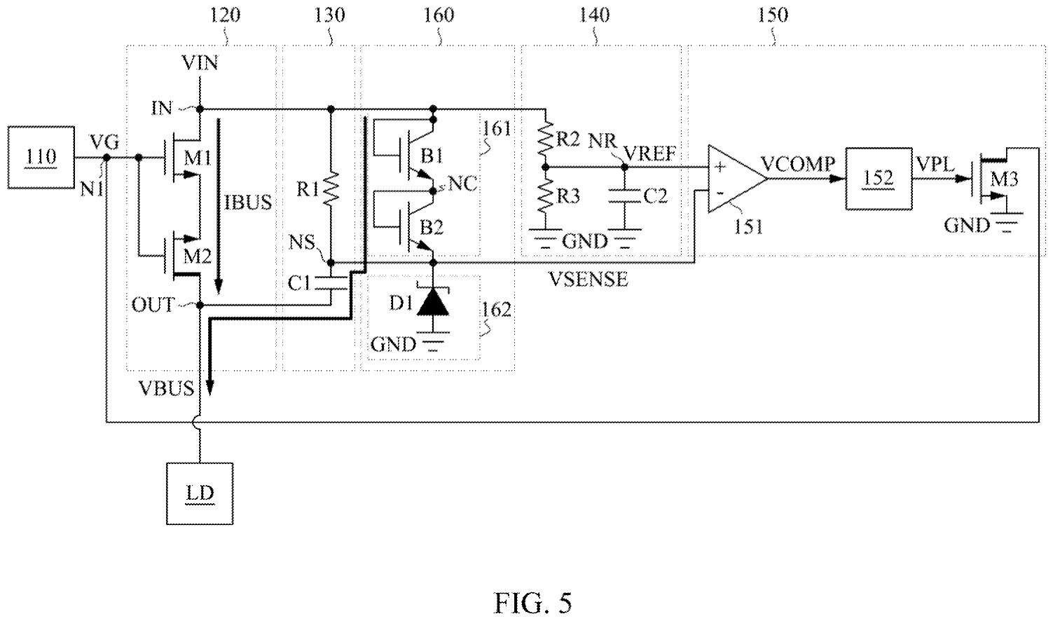

As illustrated in FIG. 1, the protection circuit 160 includes a transient state protection circuit 161 and a transient state protection circuit 162. The details about operations of the transient state protection circuit 161 and the transient state protection circuit 162 are described with reference to FIG. 4 and FIG. 5 in following paragraphs.

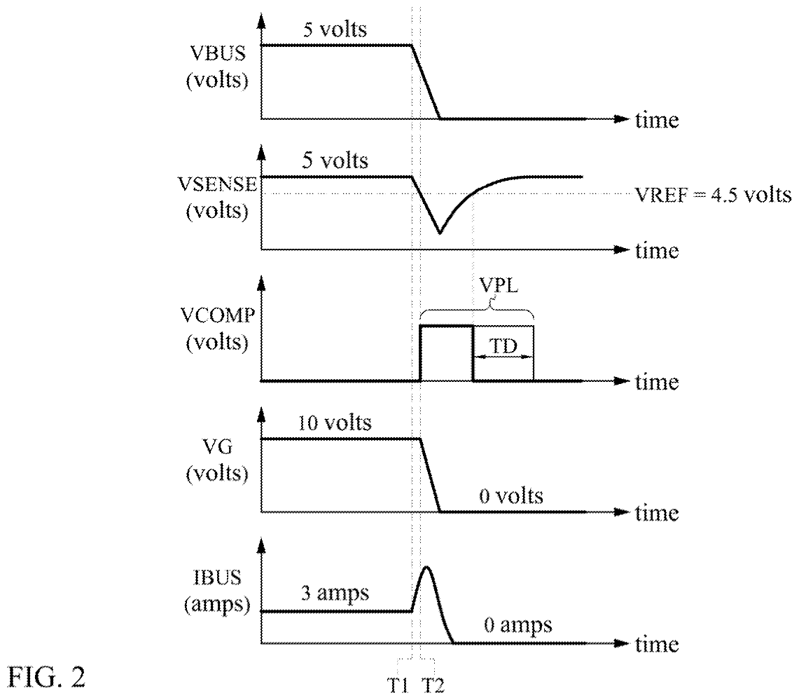

References are made to FIG. 1 and FIG. 2. FIG. 2 is a waveform diagram of the power supply circuit 100 in FIG. 1 according to some embodiments of the present disclosure.

As illustrated in FIG. 2, before a time point T1, the output voltage VBUS has a fixed voltage value (e.g., 5 volts).

At the time point T1, when the state of the load LD changes (e.g., from a light-load state to a heavy-load state) or when the output terminal OUT is short-circuited, the output voltage VBUS decreases rapidly and the output current IBUS increases rapidly. Since the output voltage VBUS decreases rapidly, the sensing voltage VSENSE also decreases rapidly based on the coupling effect of the capacitor C1.

At a time point T2, when the sensing voltage VSENSE is lower than the reference voltage VREF, the comparison voltage VCOMP changes to a high logic value (e.g., a logic value 1).

Then, the delay circuit 152 can delay the falling edge of the comparison voltage VCOMP with a delay duration TD (e.g., 500 nanoseconds but the present disclosure is not limited thereto) to generate the delayed voltage VPL. In other words, compared to a pulse width of the comparison voltage VCOMP, a pulse width of the delayed voltage VPL is wider. The delay circuit 152 transmits the delayed voltage VPL to the control terminal (the gate terminal) of the transistor M3. Accordingly, the transistor M3 is turned on according to the delayed voltage VPL with the high logic value. The control voltage VG is pulled down (e.g., pulled down from 10 volts to 0 volts) by a ground voltage at the ground terminal GND through the turned-on transistor M3. Since the control voltage VG is pulled down, the power switch M1 and the power switch M2 are turned off. Accordingly, the output current IBUS becomes smaller to realize the short-circuit protection. By operations of the delay circuit 152, the pulse width of the comparison voltage VCOMP can be extended. When the pulse width of the comparison voltage VCOMP is too narrow, there is insufficient time to pull the control voltage VG down to 0 volts.

In some related approaches, the short-circuit protection is activated only when an output voltage is lower than a reference voltage. However, under a condition that the reference voltage is set to a higher value, there is the problem of activating the short-circuit protection by mistake (since it is more sensitive). Under a condition that the reference voltage is set to a lower value, although it can make the short-circuit protection less likely to be activated by mistake, it causes the short-circuit protection to be activated later and cannot achieve the effect of avoiding circuit burnout.

Compared to the related approaches above, the present disclosure does not directly compare the output voltage VBUS with the reference voltage VREF. The present disclosure utilizes the slew rate sensing circuit 130 to detect the change degree of output voltage VBUS to generate the sensing voltage VSENSE, and then utilizes the protection circuit 150 to compare the sensing voltage VSENSE with the reference voltage VREF to activate the subsequent short-circuit protection. Thus, the reference voltage VREF in the present disclosure can be set to be higher and the present disclosure can achieve the effect of avoiding activating the short-circuit protection by mistake and avoiding activating the short-circuit protection too late. As described above, when the output voltage VBUS changes drastically, the sensing voltage VSENSE will change drastically. For example, when the sensing voltage VSENSE decreases to be equal to the reference voltage VREF (e.g., 4.5 volts), the output voltage VBUS may have been decreased to 3 volts. Accordingly, when the reference voltage VREF is set to be higher (e.g., 4.5 volts), the circuit can still operate normally before the output voltage VBUS decreases to 3 volts, so as to avoid activating the short-circuit protection when the output voltage VBUS has not been too low. In addition, since the time point when the sensing voltage VSENSE decreases to be equal to the higher reference voltage VREF (e.g., 4.5 volts) is not too late, it can also avoid activating the short-circuit protection too late.

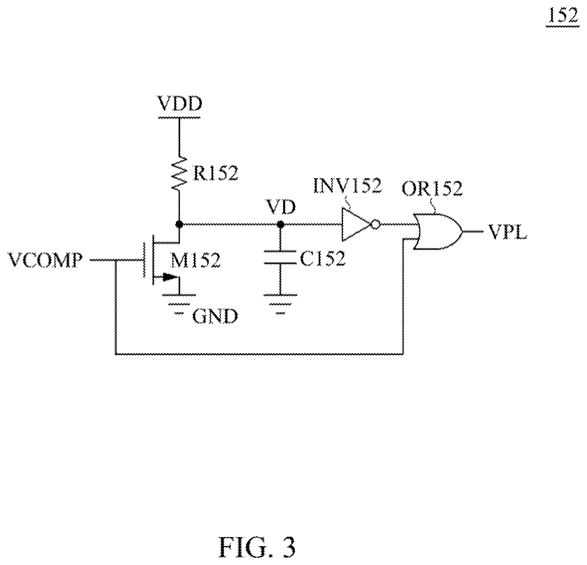

References are made to FIG. 3 and FIG. 4. FIG. 3 is a schematic diagram of the delay circuit 152 in FIG. 1 according to some embodiments of the present disclosure. FIG. 4 is a waveform diagram of the delay circuit 152 in FIG. 3 according to some embodiments of the present disclosure.

As illustrated in FIG. 3, the delay circuit 152 includes a resistor R152, a transistor M152, a capacitor C152, an inverter INV152, and an OR gate OR152. The resistor R152 is coupled between a power voltage VDD and a first terminal (a drain terminal) of the transistor M152. A second terminal (a source terminal) of the transistor M152 is coupled to the ground terminal GND. A control terminal (a gate terminal) of the transistor M152 can receive the comparison voltage VCOMP. The first terminal (the drain terminal) of the transistor M152 is further coupled to a first terminal of the capacitor C152 and an input terminal of the inverter INV152. An intermediate voltage VD is generated at the input terminal of the inverter INV152. A second terminal of the capacitor C152 is coupled to the ground terminal GND. An output terminal of the inverter INV152 is coupled to a first input terminal of the OR gate OR152. A second input terminal of the OR gate OR152 can receive the comparison voltage VCOMP. An output terminal of the OR gate OR152 can output the delayed voltage VPL.

As illustrated in FIG. 3 and FIG. 4, at a time point T4, the comparison voltage VCOMP changes from a low logic value (e.g., a logic value 0) to the high logic value (a rising edge). The transistor M152 is turned on. The intermediate voltage VD is pulled down by the ground voltage at the ground terminal GND through the turned-on transistor M152 to change from the high logic value to the low logic value. An output signal of the inverter INV152 changes from the low logic value to the high logic value. Based on the OR operation of the OR gate OR152 (the comparison voltage VCOMP and the output signal of the inverter INV152 change from the low logic value to the high logic value), the delayed voltage VPL changes from the low logic value to the high logic value.

At a time point T5, the comparison voltage VCOMP changes from the high logic value to the low logic value (a falling edge). The transistor M152 is turned off. The power voltage VDD charges the intermediate voltage VD through the resistor R152.

At a time point T6, the intermediate voltage VD is charged to be equal to a transition voltage of the OR gate OR152. At this time, the output signal of the inverter INV152 changes form the high logic value to the low logic value. Based on the OR operation of the OR gate OR152 (the comparison voltage VCOMP and the output signal of the inverter INV152 change from the high logic value to the low logic value), the delayed voltage VPL changes from the high logic value to the low logic value.

As shown in FIG. 4, by operations of the delay circuit 152, a falling edge of the delayed voltage VPL (the output of the delay circuit 152) is later than the falling edge of the comparison voltage VCOMP (the input of the delay circuit 152).

Reference is made to FIG. 5. FIG. 5 is a schematic diagram of operations of the transient state protection circuit 161 in FIG. 1 according to some embodiments of the present disclosure.

The transient state protection circuit 161 is coupled between the input terminal IN and the sensing node NS. As illustrated in FIG. 5, the transient state protection circuit 161 includes a bipolar junction transistor B1 and a bipolar junction transistor B2. The bipolar junction transistor B1 is coupled between the input terminal IN and a connection node NC. The bipolar junction transistor B2 is coupled between the connection node NC and the sensing node NS. In some situations, the output terminal OUT may be short-circuited from a high voltage (e.g., 20 volts) to a low voltage (e.g., 0 volts). By the protection of the bipolar junction transistor B1 (its across voltage is, for example, 0.7 volts) and the bipolar junction transistor B2 (its across voltage is, for example, 0.7 volts), the sensing voltage VSENSE is limited to a difference value (e.g., 3.6 volts) between the input voltage VIN (e.g., 5 volts) and the sum of the across voltages (e.g., 1.4 volts). Since the sensing voltage VSENSE is limited to the more appropriate range, the comparator 151 can be protected. In some other embodiments, the bipolar junction transistor B1 and the bipolar junction transistor B2 can be replaced by metal oxide semiconductor field effect transistors or diodes. However, the bipolar junction transistor has the advantage of less process drift.

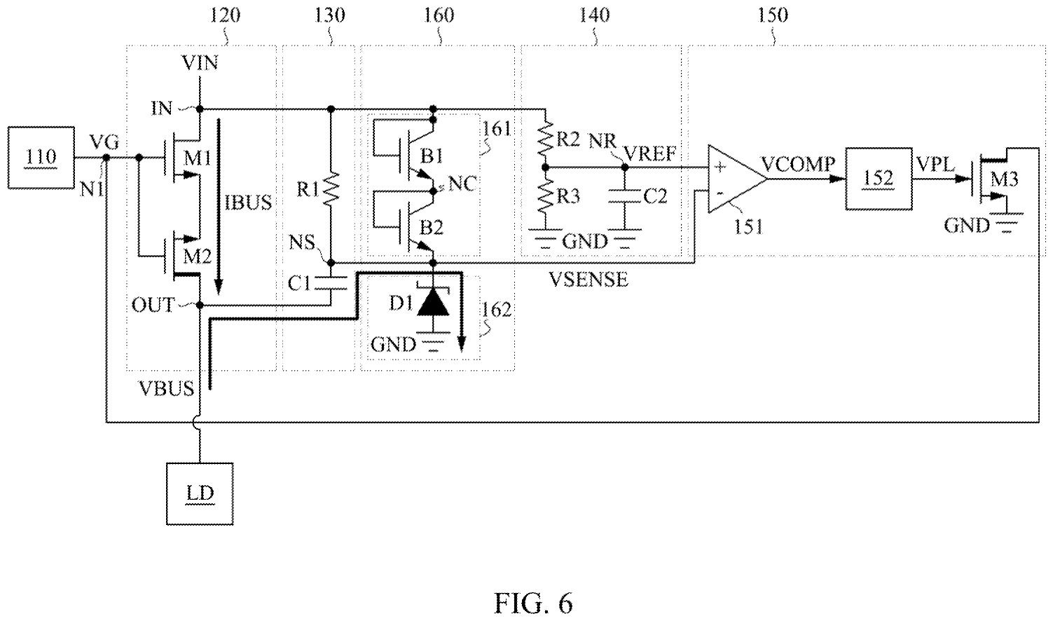

Reference is made to FIG. 6. FIG. 6 is a schematic diagram of operations of the transient state protection circuit 162 in FIG. 1 according to some embodiments of the present disclosure.

The transient state protection circuit 162 is coupled between the sensing node NS and the ground terminal GND. As illustrated in FIG. 6, the transient state protection circuit 162 includes a Zener diode D1. The Zener diode D1 is coupled between the sensing node NS and the ground terminal GND. In some situations, the output terminal OUT may be short-circuited from a low voltage (e.g., 0 volts) to a high voltage (e.g., 20 volts). By the protection of the Zener diode D1, the sensing voltage VSENSE is limited to not exceed the reverse breakdown voltage of the Zener diode D1 (e.g., 6 volts). Since the sensing voltage VSENSE is limited to the more appropriate range, the effect of protecting the comparator 151 can be achieved. In some other embodiments, the Zener diode D1 can be replaced by one or more metal oxide semiconductor field effect transistors or diodes.

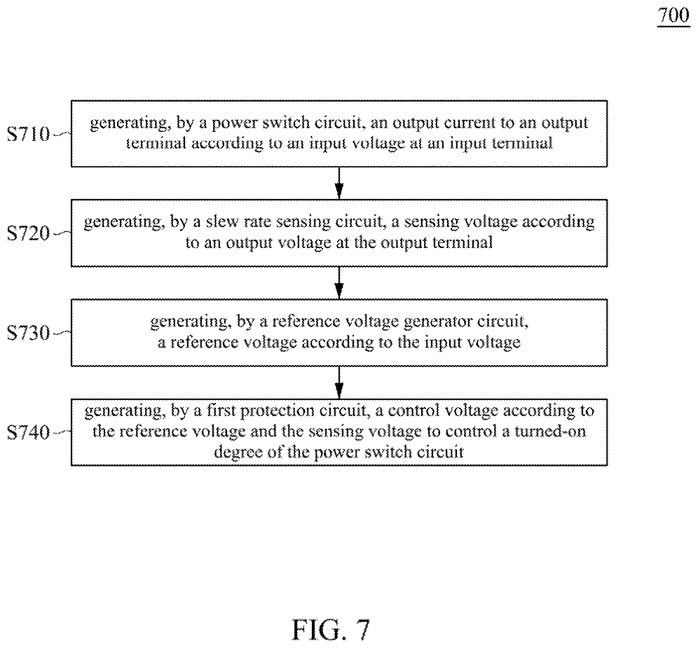

Reference is made to FIG. 7. FIG. 7 is a flowchart diagram of a control method 700 of a power supply circuit according to some embodiments of the present disclosure. In some embodiments, the control method 700 can be applied to the power supply circuit 100 in FIG. 1, but the present disclosure is not limited thereto. For better understanding, the control method 700 is described with reference to the power supply circuit 100 in FIG. 1 in following paragraphs.

As illustrated in FIG. 7, the control method 700 includes operation S710, operation S720, operation S730, and operation S740.

In operation S710, the power switch circuit 120 generates the output current IBUS to the output terminal OUT according to the input voltage VIN at the input terminal IN. In the example of FIG. 1, the power switch circuit 120 is implemented by the power switch M1 and the power switch M2 connected back to back.

In operation S720, the slew rate sensing circuit 130 generates the sensing voltage VSENSE according to the output voltage VBUS at the output terminal OUT. In the example of FIG. 1, the slew rate sensing circuit 130 is implemented by the high-pass filter.

In operation S730, the reference voltage generator circuit 140 generates the reference voltage VREF according to the input voltage VIN. In the example of FIG. 1, the reference voltage generator circuit 140 is implemented by the voltage divider circuit.

In operation S740, the protection circuit 150 generates the control voltage VG according to the reference voltage VREF and the sensing voltage VSENSE to control the turned-on degree of the power switch circuit 120. In the example of FIG. 1, the protection circuit 150 is implemented by the comparator 151, the delay circuit 152, and the transistor M3.

As described above, the present disclosure can optimize the short-circuit protection mechanism by the cooperative operation of the slew rate sensing circuit and the reference voltage generator circuit.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A power supply circuit, comprising:
a power switch circuit configured to generate an output current to an output terminal of the power switch circuit according to an input voltage at an input terminal;
a slew rate sensing circuit configured to generate a sensing voltage according to an output voltage at the output terminal of the power switch circuit;
a reference voltage generator circuit configured to generate a reference voltage according to the input voltage; and
a first protection circuit configured to generate a control voltage according to the reference voltage and the sensing voltage to control a turned-on degree of the power switch circuit.

2. The power supply circuit of claim 1, wherein the slew rate sensing circuit comprises:
a resistor coupled between the input terminal and a sensing node; and
a capacitor coupled between the sensing node and the output terminal of the power switch circuit,
wherein the sensing voltage is generated at the sensing node.

3. The power supply circuit of claim 1, wherein the reference voltage generator circuit comprises:
a first resistor coupled between the input terminal and a reference node;
a second resistor coupled between the reference node and a ground terminal; and
a capacitor coupled between the reference node and the ground terminal,
wherein the reference voltage is generated at the reference node.

4. The power supply circuit of claim 1, wherein the first protection circuit comprises:
a comparator configured to compare the reference voltage with the sensing voltage to generate a comparison voltage; and
a transistor coupled between an output terminal of the comparator, a ground terminal, and the power switch circuit, wherein the comparison voltage is configured to control a turned-on degree of the transistor.

5. The power supply circuit of claim 4, wherein the first protection circuit further comprises:
a delay circuit configured to delay the comparison voltage to generate a delayed voltage and transmit the delayed voltage to a control terminal of the transistor to control the turned-on degree of the transistor.

6. The power supply circuit of claim 1, further comprising:
a second protection circuit, comprising:
a first transient state protection circuit coupled between the input terminal and a sensing node; and
a second transient state protection circuit coupled between the sensing node and a ground terminal,
wherein the sensing voltage is generated at the sensing node.

7. The power supply circuit of claim 6, wherein the first transient state protection circuit comprises:
a first bipolar junction transistor coupled between the input terminal and a connection node; and
a second bipolar junction transistor coupled between the connection node and the sensing node.

8. The power supply circuit of claim 6, wherein the second transient state protection circuit comprises:
a Zener diode coupled between the sensing node and the ground terminal.

9. The power supply circuit of claim 1, wherein the power switch circuit comprises:
a first power switch; and
a second power switch connected to the first power switch back to back between the input terminal and the output terminal of the power switch circuit.

10. The power supply circuit of claim 9, wherein the first power switch and the second power switch are N-type transistors, and the power supply circuit further comprises:
a charge pump circuit coupled to a control terminal of the first power switch and a control terminal of the second power switch.

11. A control method of a power supply circuit, comprising:
generating, by a power switch circuit, an output current to an output terminal of the power switch circuit according to an input voltage at an input terminal;
generating, by a slew rate sensing circuit, a sensing voltage according to an output voltage at the output terminal of the power switch circuit;
generating, by a reference voltage generator circuit, a reference voltage according to the input voltage; and
generating, by a first protection circuit, a control voltage according to the reference voltage and the sensing voltage to control a turned-on degree of the power switch circuit.

12. The control method of the power supply circuit of claim 11, further comprising:
generating, by the slew rate sensing circuit, the sensing voltage at a sensing node,
wherein a resistor in the slew rate sensing circuit is coupled between the input terminal and the sensing node, and a capacitor in the slew rate sensing circuit is coupled between the sensing node and the output terminal of the power switch circuit.

13. The control method of the power supply circuit of claim 11, further comprising:
generating, by the reference voltage generator circuit, the reference voltage at a reference node,
wherein a first resistor in the reference voltage generator circuit is coupled between the input terminal and the reference node, a second resistor in the reference voltage generator circuit is coupled between the reference node and a ground terminal, and a capacitor in the reference voltage generator circuit is coupled between the reference node and the ground terminal.

14. The control method of the power supply circuit of claim 11, further comprising:
comparing, by a comparator in the first protection circuit, the reference voltage with the sensing voltage to generate a comparison voltage; and
controlling a turned-on degree of a transistor in the first protection circuit by the comparison voltage,
wherein the transistor is coupled between an output terminal of the comparator, a ground terminal, and the power switch circuit.

15. The control method of the power supply circuit of claim 14, further comprising:
delaying, by a delay circuit in the first protection circuit, the comparison voltage to generate a delayed voltage; and
transmitting, by the delay circuit, the delayed voltage to a control terminal of the transistor to control the turned-on degree of the transistor.

16. The control method of the power supply circuit of claim 11, further comprising:
generating, by the slew rate sensing circuit, the sensing voltage at a sensing node,
wherein a first transient state protection circuit in a second protection circuit is coupled between the input terminal and the sensing node, and a second transient state protection circuit in the second protection circuit is coupled between the sensing node and a ground terminal.

17. The control method of the power supply circuit of claim 16, wherein the first transient state protection circuit comprises:
a first bipolar junction transistor coupled between the input terminal and a connection node; and
a second bipolar junction transistor coupled between the connection node and the sensing node.

18. The control method of the power supply circuit of claim 16, wherein the second transient state protection circuit comprises:
a Zener diode coupled between the sensing node and the ground terminal.

19. The control method of the power supply circuit of claim 11, wherein the power switch circuit comprises:
a first power switch; and
a second power switch connected to the first power switch back to back between the input terminal and the output terminal of the power switch circuit.

20. The control method of the power supply circuit of claim 19, wherein the first power switch and the second power switch are N-type transistors, and the power supply circuit further comprises:
a charge pump circuit coupled to a control terminal of the first power switch and a control terminal of the second power switch.
